(19) United States
(12) Patent Application Publication
(10) Pub. No.: US 2012/0189261 A1
(43) Pub. Date: Jul. 26, 2012

(54) CONNECTOR MODULE FOR TELECOMMUNICATION PATCH PANELS

(76) Inventors: Friedrich W. Denter, Castrop-Rauxel (DE); Joerg Reinhardt, Kutenholz (DE); Nelson Goncalves Pimentel, Neuss (DE); Ulrich Lutterkordt, Wuppertal (DE)

(21) Appl. No.: 13/496,310

(22) PCT Filed: Oct. 6, 2010
(86) PCT No.: PCT/US10/51607

§ 371 Date: Mar. 15, 2012

(30) Foreign Application Priority Data
Oct. 7, 2009 (GB) 0917498.8

(51) Int. Cl. G02B 6/36

(52) U.S. Cl. 385/135

(57) ABSTRACT

A connector module (15) for use in a telecommunications patch panel (1) comprises at least one front connector port (21) positioned to receive a patch cord incoming to the module from the front side of a patch panel; and a respective cable-attachment member (23) to which a cable, incoming to the module from the rear side of a patch panel, can be secured. The module (15), including its cable-attachment member (23) and any cable secured thereto, can be inserted into and withdrawn from the patch panel (1) from the front side of the panel. The module may further comprise a rear connector port (19) positioned to receive a cable incoming to module from the rear side of a patch panel.

The present invention relates to telecommunication systems and, in particular, patch panels for use in such systems. The invention is concerned more especially, but not exclusively, with fibre-optic telecommunication systems.

### BACKGROUND

Patch panels are employed in telecommunication systems to enable the interconnections provided by a system to be changed as required. A patch panel typically has connector ports on the front side into which so-called patch cords can be plugged as required, and connector ports at the rear of the panel into which longer and more permanent cables are usually connected. Patch panels are often arranged on racks so that the connector ports on the front side of the panel are exposed and readily accessible. The connector ports at the rear of the panel may be accessible from the rear of the rack but, if that is difficult or impossible, provision must be made for access from the front of the panel.

Communication systems employing fibre-optic connectivity in the form of fibre-optic cables and connection devices are found, for example, in data centres where they are used to transport traffic between various components of the computer equipment in the data centre and between the data centre and the outside world. They are also used in so-called FTTx applications, in which optical signals are routed from a central office to locations such as the premises or homes of customers. A known form of patch panel for fibre-optic communication systems comprises a tray that can be pulled out, in the manner of a drawer, from the front of the rack in which the panel is installed, to provide access to the rear connector ports. In some cases, the connector ports are provided on a plurality of modules each of which can then be taken out individually from the opened tray as required. Examples of such patch panels are the “Fiber Optic Modular Patch Panel” available from RiT Technologies Ltd. of Tel Aviv, Israel, and the “Modular Sliding Tray Patch Panel” available from Hellermann Tyton Data Ltd of Brackmills, Northampton, England.

Another form of patch panel employing modules in the form of pre-terminated cassettes is described in U.S. 2008/089656 (Wagner et al).

In accessing connector ports at the rear of a patch panel with incoming fibre-optic cables and/or patch cords, care is required to ensure that those cables/patch cords are not subject to mechanical stresses that could disturb the alignment of the optical fibres and cause the data signals transmitted by those cables/patch cords to be changed or lost. It may also be desirable in some circumstances to minimize disruption to copper-wire cables and/or patch cords incoming to a patch panel. With that in mind, the present invention is concerned with the provision of connector modules for use in patch panels (more especially, but not exclusively, fibre-optic patch panels) that enable connector ports at the rear of a patch panel to be accessed without substantial risk of disturbing the connections at the rear of the panel and any already-connected patch cords at the front of the panel.

### SUMMARY

The present invention provides a connector module for use in a telecommunications patch panel, the module comprising a front connector port positioned in the housing to receive a patch cord incoming to the module from the front side of a patch panel; and a cable-attachment member to which a cable incoming to the module from the rear side of a patch panel can be secured.

The cable attachment member may extend from a housing of the connector module.

The presence of the cable attachment member in a connector module in accordance with the invention facilitates the handling of the module without disruption to any cables secured to the attachment member. Alternatively, if the module is installed in a patch panel in proximity to other connector modules, any cables secured to the attachment member are less likely to be disturbed as a result of those other modules being handled. The advantages offered by the cable attachment member are especially, but not exclusively, significant when the connector module is intended for use in a fibre-optic patch panel, or a patch panel that provides some fibre-optic connectivity.

In an embodiment of the invention, the connector module further comprises a rear connector port positioned in the housing to receive a cable incoming to the module from the rear side of the patch panel. The module may further comprise a circuit assembly within the housing to connect the front and rear connector ports. Such a module may be provided to an end user in pre-wired form. An alternative embodiment of the invention offers the end-user the possibility of selecting the circuit assembly provided within the module. The circuit assembly may, in either case, provide a direct connection between the front and rear connector ports or it may comprise a splitter, amplifier, switch, or measurement module of any suitable type known for use in telecommunication systems. In the particular case in which the connector module is a fibre-optic connector module, the circuit assembly provided within the module may connect single-fibre connector ports at the front of the module with either single-fibre or multi-fibre connector ports at the rear of the module.

A patch panel comprising a connector module in accordance with the invention is advantageously constructed to enable the module to be withdrawn from the front of the panel, together with the cable-attachment member and any cable(s) secured thereto, without disturbing any adjacent connector modules. The patch panel may, for example, be in the form of a tray on which a plurality of connector modules in accordance with the invention can be located, each module being removable from the tray, together with the cable-attachment member and any cable(s) secured thereto, without moving the tray and disturbing any of the other connector modules on the tray. Such an arrangement allows any of the connector modules to be removed from the patch panel without disruption to cables incoming to that module and secured to its cable-attachment member, and without disruption to the already-installed connections to the other connector modules on the tray and any related data transmission that is in progress.

### BRIEF DESCRIPTION OF THE DRAWINGS

By way of example only, embodiments of the invention will be described with reference to the accompanying drawings, in which:

FIG. 1 is a front view of an empty fibre-optic patch panel installed on a rack;

FIG. 2 shows the patch panel removed from the rack;

FIG. 3 is a perspective view of a connector module in accordance with the invention;

FIG. 4 shows the connector module of FIG. 3 in position on the patch panel of FIG. 2;

FIG. 5 shows the patch panel installed on a rack with a connected connector module pulled out of the panel;

FIG. 6 illustrates the function of the shaping of the rear edge of the patch panel;

FIGS. 7 and 8 show alternative connector modules in accordance with the invention; and

FIG. 9 is a diagram illustrating possible connections within the module of FIG. 3.

### DETAILED DESCRIPTION

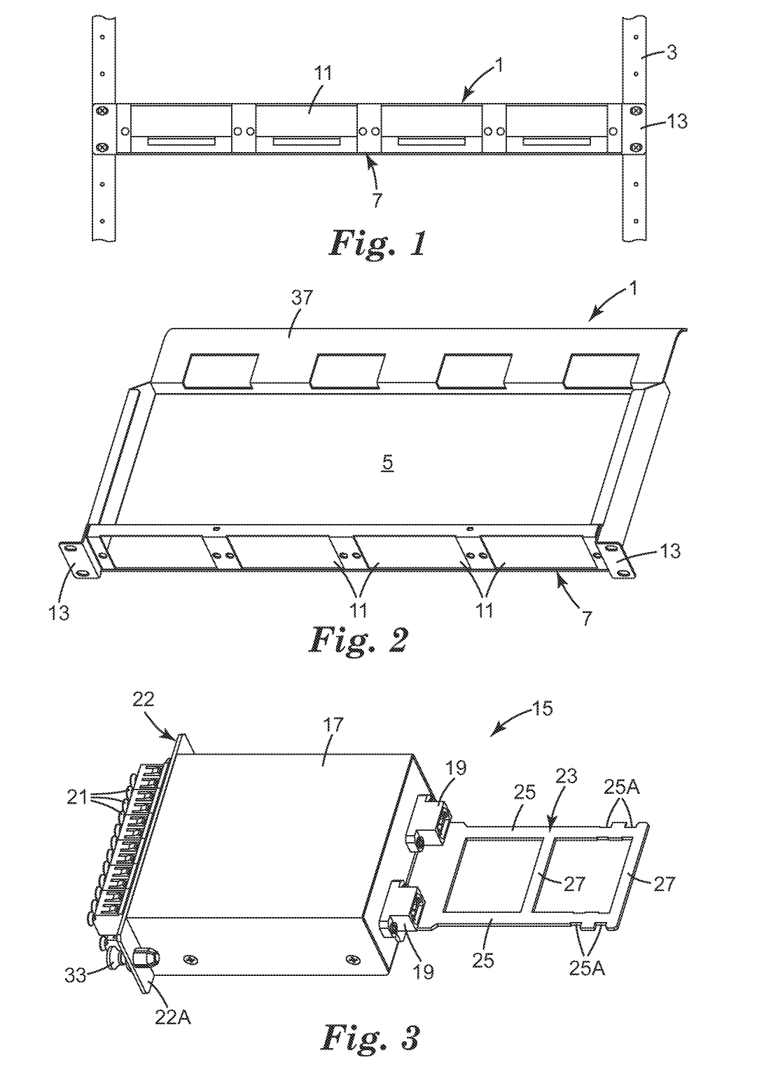

FIG. 1 shows an empty fibre-optic patch panel 1 installed on a rack 3. The panel is in the form of a tray (see FIG. 2) having a base 5 and a front face 7, only the latter being visible in FIG. 1. The panel 1 has four apertures 11 in its front face 7, the purpose of which will be described below, and is mounted on the rack 3 by means of brackets 13, conventionally in a stack with other similar panels. It will be apparent from the description below that the number of apertures 11 in the front face 7 is a matter of choice, and more or fewer apertures could be provided as required.

In use, four connector modules (not shown in FIGS. 1 and 2) are arranged on the base 5 of the panel 1 with the fronts of the modules located in the apertures 11. As described below, each connector module provides at least one connector port at the rear of the patch panel 1, connected to a respective cable incoming to the rear of the panel, and one or more connector ports at the front of the panel into which patch cords can be plugged as required.

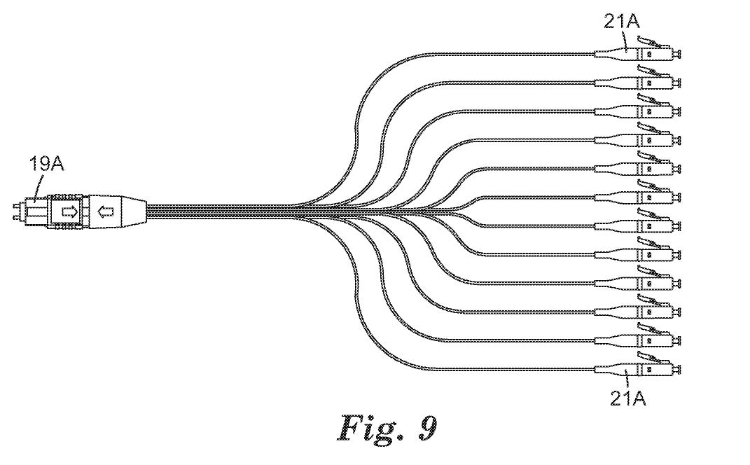

FIG. 3 shows a connector module 15 in accordance with the invention, suitable for use in the patch panel 1. The module comprises a housing 17 at the rear of which are two multi-fibre connector ports 19 (for example, MPO connector ports) each connected, within the module, to a respective set of twelve single fibre connector ports 21 (for example LC connector ports) on the front face 22 of the module. The connector ports 19, 21 are conventional and well known in the field of fibre-optic communication systems, and need not be described in detail here. The connection between one of the multi-fibre ports 19 and its associated single-fibre ports may comprise a so-called “Fan Out” circuit assembly, also well known in the field of fibre-optic communication systems. FIG. 9 is a diagram illustrating such an assembly comprising, within the module, an MPO connector 19A which is coupled into one of the multi-fibre ports 19 and connected by optical fibres to twelve connectors 21A each coupled into a respective one of the single-fibre ports 21.

A cable-attachment frame 23 extends rearwardly from the housing 17 of the connector module 15, providing a structure to which multi-fibre cables (not shown in FIG. 3) incoming to the rear connector ports 19 can be secured in any suitable way, for example by cable ties. More particularly, the cable attachment frame 23 comprises two side arms 25 extending from connector module 15 and interconnected by two cross-pieces 27. Each side arm 25 is shaped towards its outer end to provide narrowed-down portions 25A, defining cable-securing locations.

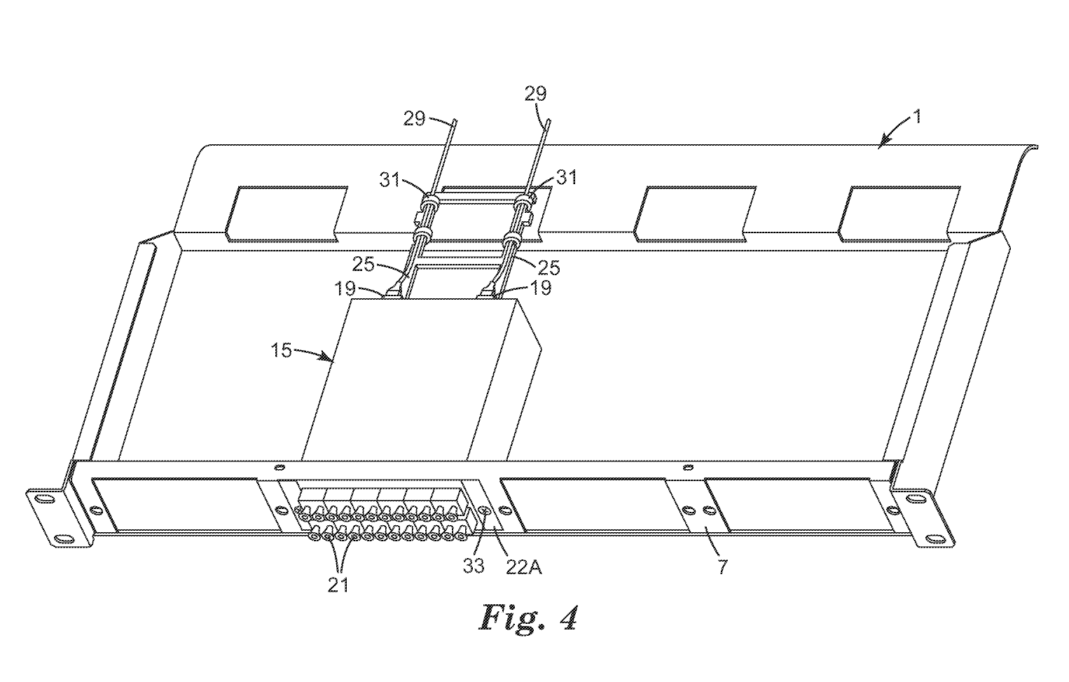

FIG. 4 shows the connector module 15 installed in the patch panel 1, with a multi-fibre cable 29 connected to each of the rear connector ports 19. For the purposes of illustration, the frame 3 has been omitted from FIG. 4: however, it will be understand from the description below that the patch panel 1 would be in position on the rack when the connector module is installed. Each cable 29 is incoming to the module 15 from the rear of the patch panel 1 and is connected by a cable tie 31 to a respective side arm 25 of the cable-attachment frame 23 at the cable-securing location 25A. The installation is effected by first pulling the cables 29 to the front of the patch panel 1 through the appropriate aperture 11, following which they are connected to the multi-fibre connector ports 19 at the rear of the module, and secured to the cable-attachment frame 23. The cables 29 are then pushed back into the panel 1 through the aperture 11 followed by the connected module 15 until extensions 22A on each side of the front face 22 of the module rest against the front face 7 of the panel 1. The module 15 is then secured to the panel by suitable fasteners 33 extending through aligned holes in both the extensions 22A and the front face 7. The fasteners 33 are shown as being plastic rivets but any suitable form of fastener could be used. The single-fibre ports 21 of the module 15 are accessible at the front of the panel 1 to receive plugs at the ends of single fibre patch cords. Other modules 15 can be similarly installed as required through the other apertures 11 in the front face 7 of the panel 1.

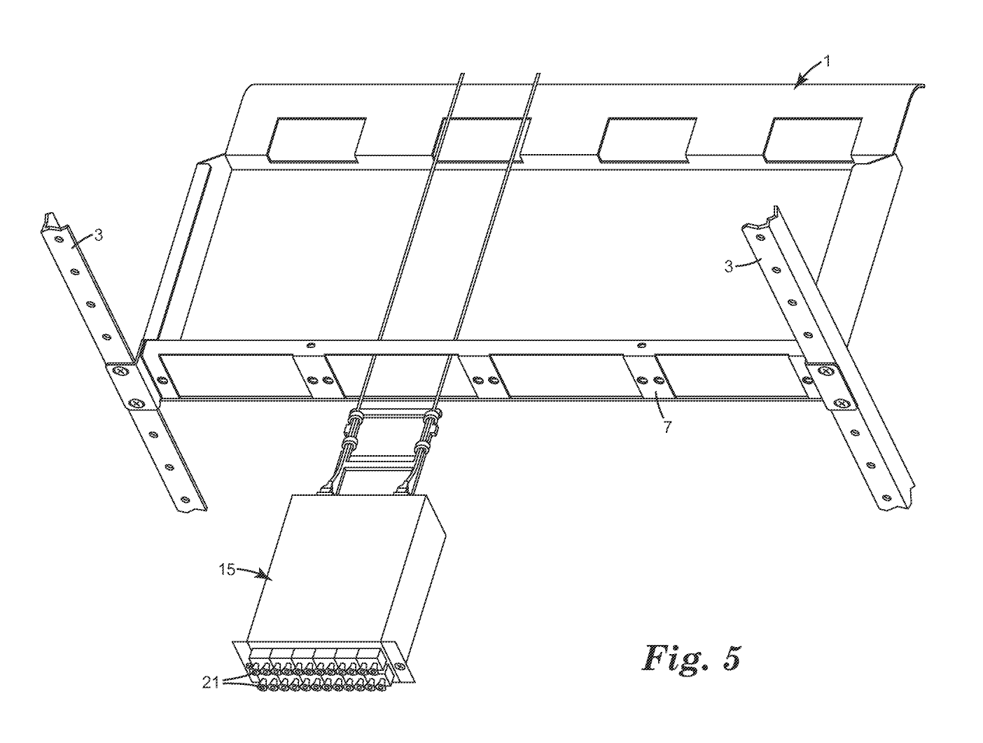

Any of the modules 15 installed in the patch panel 1 can be accessed as required by removing the fasteners 33 and pulling the module out the panel through its respective aperture 11 (followed by the attached cables 29) as illustrated in FIG. 5. During this procedure, the attachment of the cables 29 to the frames 23 reduces the risk of the cables 29 being subjected to mechanical stresses that could disrupt the alignment of the optical fibres and have an adverse effect on the performance of the cables. As a result, handling of any of the modules 15 is facilitated, both during installation of the patch panel and during data transmission. Moreover, removal of any one of the modules 15 from the patch panel will have no effect on the existing connections (cables and patch panels) to the other modules in the patch panel, which remain undisturbed.

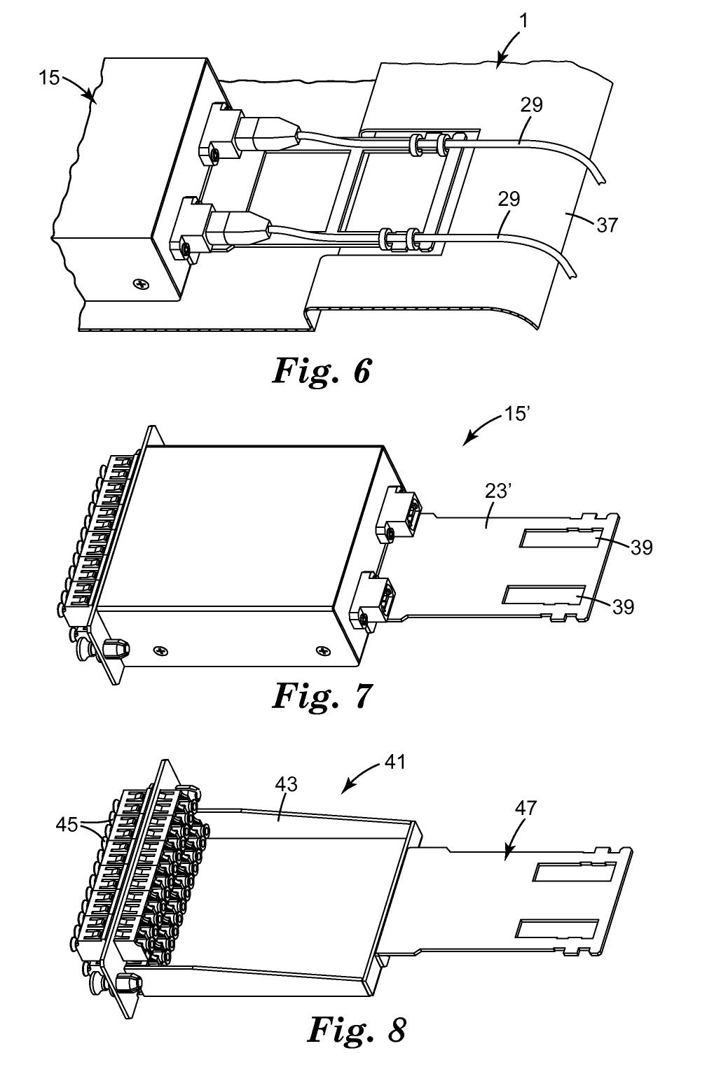

Effective performance of the cables 29 is further ensured by the provision of a rounded rear edge 37 on the base 5 of the patch panel 1. The shape of the rounded edge 37 is selected to ensure that any cable 29 that is passed around the back of the tray 5, as illustrated in FIG. 6, is forced to adopt a shape that respects the minimum bending radius on the cable and does not disrupt the transmission of optical data signals by the cable.

It will be appreciated that the shape of the attachment frame 23 of the connector module can be modified to take account of the situation in which the module is used. FIG. 7, for example, shows a module 15′ similar to the module 15 of FIG. 3 but having an alternative form of cable attachment frame 23′. In this case, the attachment frame 23′ has the form of a plate, offering enhanced stability, with two apertures 39 through which cable ties can be passed to secure cables to the frame.

An alternative form of connector module 41 is shown in FIG. 8. This connector module differs from the modules 15, 15′ in that it is not pre-wired. Instead, the housing 43 of the module is open and the module is provided only with single fibre connector ports 45 in its front face to which any desired connections can be made. A cable attachment frame 47 extends from the rear of the connector module 41 to which incoming cables at the rear of the module can be secured as described above, regardless of the connections that are established within the module. The cable attachment frame shown in FIG. 8 is similar to that of FIG. 7 but it could have any suitable shape including that of the frame 23 of FIG. 3.

The connector module 41 of FIG. 8 may be used in a similar manner to the modules 15, 15′ of FIGS. 3 and 7, in which case a suitable circuit assembly (for example, one similar to that shown in FIG. 9) would be provided within the module to connect the single-fibre connector ports 45 with multi-fibre connectors at the rear of the module. However, other forms of circuit assembly could be provided if required including, for example, one that connects the single-fibre connector ports 45 with other single-fibre connectors (for example, LC or SC connectors) at the rear of the module. As further alternatives, an optical splitter, amplifier, switch, or measurement module could be provided within the connector module 41.

It will be appreciated that the type and quantity of connector ports provided at the front of the connector module and, where applicable, at the rear of the module would be selected having regard to the situation in which the module is to be used. The number of connector modules 15, 15′, 41 can also be varied and, correspondingly, the number of apertures 11 in the front face 7 of the patch panel 1.

It will further be appreciated that the patch panel 1 and connector modules 15, 15′, 41 described above are not restricted to use in fibre-optic communication systems but could also be used in copper wire communication systems, or systems employing both fibre-optic and copper-wire connectivity, when it is desired to reduce disruption to the already-installed connections to a patch panel during modification/installation of adjacent connections and/or to facilitate handling of any of the connector modules, especially when accessing cabling at the rear of the patch panel.

1. A connector module for use in a telecommunications patch panel, the module comprising at least one front connector port positioned to receive a patch cord incoming to the module from the front side of a patch panel; and a respective cable-attachment member to which a cable, incoming to the module from the rear side of a patch panel, can be secured; wherein the module, including its cable-attachment member and any cable secured thereto, can be inserted into and withdrawn from the patch panel from the front side of the panel.

2. A module as claimed in claim 1, further comprising a rear connector port positioned in the housing to receive a cable incoming to module from the rear side of a patch panel.

3. A module as claimed in claim 2, further comprising a circuit assembly within the housing to connect the said front and rear connector ports.

4. A module as claimed in claim 1, wherein the cable-attachment member comprises a frame to which a cable incoming to the module from the rear side of a patch panel can be secured.

5. A module as claimed in claim 4, in which part of the frame is shaped to define a cable-securing location.

6. A module as claimed in claim 2, in which the connector ports are fibre-optic connector ports.

7. A module as claimed in claim 6, in which the rear connector port is a multi-fibre port.

8. A module as claimed in claim 6, in which the front connector port is a single-fibre connector port.

9. A module as claimed in claim 8, comprising a plurality of single-fibre front connector ports each positioned in the housing to receive a respective patch cord incoming to the module from the front side of a patch panel.

10. A patch panel comprising a module as claimed in claim 1, the module being located in the patch panel with the front connector port(s) accessible from the front of the patch panel.

11. A patch panel as claimed in claim 10, in which the module is positioned in an aperture in the panel and can be withdrawn from the panel through the aperture from the front of the panel.

12. A patch panel as claimed in claim 11, in which the module is releasably-secured in the aperture in the patch panel

13. A patch panel as claimed in claim 10, wherein the panel comprises a guiding surface defining a minimum bending radius for a fibre-optic cable incoming to the module from the rear side of the panel.
